(19) United States
(12) Patent Application Publication
(10) Pub. No.: US 2025/0077096 A1
(43) Pub. Date: Mar. 6, 2025

(54) STORAGE DEVICE, AUTHENTICATION DEVICE, AND AUTHENTICATION SYSTEM

(71) Applicant: SAMSUNG ELECTRONICS CO., LTD., Suwon-si (KR)

(72) Inventors: Yun-Ho Youm, Suwon-si (KR); Seung-Ho Lee, Suwon-si (KR); Myung-Sik Choi, Suwon-si (KR)

(73) Assignee: SAMSUNG ELECTRONICS CO., LTD., Suwon-si (KR)

(21) Appl. No.: 18/430,315

(22) Filed: Feb. 1, 2024

(30) Foreign Application Priority Data
Aug. 29, 2023 (KR) 10-2023-0113634

(51) Int. Cl. G06F 3/06

(52) U.S. Cl. CPC G06F 3/0622; G06F 3/0655; G06F 3/0679

(57) ABSTRACT

A storage device includes: authentication device for receiving a certificate generated based on a first private key that corresponds to a first public key, the first public key, and a second public key from a debugging device, authenticating the first public key, authenticating the second public key when the authentication of the first public key is successful, and outputting a debugging enable signal when the authentication of the second public key is successful; a processor for receiving a debugging signal from the debugging device in response to the debugging enable signal, and performing debugging based on the debugging signal.

### CROSS-REFERENCE TO RELATED APPLICATION

This application claims priority to Korean Patent Application No. 10-2023-0113634 filed in the Korean Intellectual Property Office on Aug. 29, 2023, the entire contents of which are incorporated herein by reference.

### BACKGROUND

### 1. Field

The present disclosure relates to a storage device, an authentication device, and an authentication system.

### 2. Description of the Related Art

A representative example of a flash memory-based large capacity storage device is a solid state drive (SSD). With the explosive increase in demand for SSDs, their uses are diversifying. For example, recently, as cloud computing has become popular, users have been able to store and access large capacity data using data centers with SSDs installed. The SSDs must be managed and maintained to provide high reliability and optimal service quality.

During SSD operation, unexpected failures or errors may occur due to hardware or software problems. In this case, the SSD collects the state at the time when an error or failure occurs and stores it as dump data. The collected dump data are transmitted to the host connected to the SSD. The dump data transmitted to the host is provided to a debugging device, and debugging based on the dump data is performed.

The SSDs sometime store secure or sensitive data, so the debugging must be allowed only on authenticated devices. The SSDs may include an authentication device for authenticating this debugging device. The authentication device performs a predetermined authentication procedure for the debugging device, and when the authentication is successful, the debugging may be granted to the debugging device.

### SUMMARY

The present disclosure may provide a debugging device for passing authentication of an authentication device in an environment where communication with an authentication server is impossible.

The present disclosure may provide an authentication device, a storage device, and an authentication system for authenticating a debugging device in an environment where communication with an authentication server is impossible.

The present disclosure may provide a debugging device for passing an authentication of an authentication device without submitting a master private key.

According to an aspect of the disclosure, a storage device includes: an authentication device comprising at least one memory and at least one authentication controller in communication with the at least one memory; and at least one processor in communication with the authentication device, wherein the at least one authentication controller is configured to: receive a certificate, a first public key, and a second public key from a debugger, wherein the certificate is generated based on a first private key, and wherein the first private key corresponds to the first public key, authenticate the first public key, based on successfully authenticating the first public key, authenticate the second public key, and based on successfully authenticating the second public key, output a debugging enable signal, and wherein the at least one processor is configured to: receive a debugging signal from the debugger, wherein the debugging signal is sent in response to the debugging enable signal, and perform debugging based on the debugging signal.

According to an aspect of the disclosure, an authentication device includes: at least one nonvolatile memory storing a first hash value and product information; an encryption engine in communication with the at least one nonvolatile memory; and at least one controller in communication with the at least one nonvolatile memory and the encryption engine, wherein the at least one controller is configured to: receive from a debugger a first public key, a second public key, and a certificate, verify the first public key using the first hash value, and based on successfully verifying the first public key, verify the second public key and the certificate using the first hash value, the product information, and the encryption engine.

According to an aspect of the disclosure, an authentication system includes: an authentication server configured to: manage product information of a storage device, a first public key, a first private key that corresponds to the first public key, a second public key, and a second private key that corresponds to the second public key, and generate a certificate based on the product information and the first private key in response to a request of an authenticated debugger, the authenticated debugger configured to: based on storing the certificate, the first public key, the second public key, and the second private key: cancel a connection with the authentication server, and send a debugging request to a storage device using the certificate, the first public key, the second public key, and the second private key; and the storage device configured to: verify the certificate, the first public key, and the second public key, based on successfully verifying the certificate, the first public key, and the second public key, transmit a challenge signal to the authenticated debugger, and based on receiving a response signal from the authenticated debugger, verify the response signal using the second public key, wherein the response signal is generated based on the second private key.

According to an aspect of the disclosure, an authentication system includes: a storage device; an authentication server, wherein the authentication server stores authentication data comprising a first public key, a first private key that corresponds to the first public key, a second public key, a second private key that corresponds to the second public key, and product information of the storage device; and a debugger, wherein the authentication server is configured to generate a certificate based on the product information and the first private key in response to a request from the debugger, wherein the debugger is configured to: obtain the authentication data and the certificate from the authentication server before accessing the storage device, connect to the storage device via a debugging interface, and send a debugging request to the storage device using the authentication data, and wherein the storage device is configured to: verify the certificate, the first public key, and the second public key, based on successfully verifying the certificate, the first public key, and the second public key, transmit a challenge signal to the debugger, and based on receiving a response signal from the debugger, verify the response signal using the second public key, wherein the response signal is generated based on the second private key.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 shows a block diagram of an authentication system according to an embodiment;

FIG. 2 shows a flowchart on operations of a debugging device and a server according to an embodiment;

FIG. 3 shows a flowchart of a method for generating a certificate according to an embodiment;

FIG. 4 shows a block diagram of an authentication system according to an embodiment;

FIG. 5 shows a block diagram on operations of a debugging device and a controller according to an embodiment;

FIG. 6 shows a flowchart of operations of a debugging device and an authentication device according to an embodiment;

FIG. 7 and FIG. 8 show flowcharts of an authentication method by an authentication device according to an embodiment;

FIG. 9 shows a block diagram on operations of an authentication device, a retention logic, and a processor according to an embodiment;

FIG. 10 shows a circuit diagram of an operation of a retention logic according to an embodiment;

FIG. 11 shows a block diagram of an authentication device according to an embodiment;

FIG. 12 shows a block diagram of an encryption engine according to an embodiment;

FIG. 13 shows an operation of a nonvolatile memory according to an embodiment;

FIG. 14 shows an operation of a volatile memory according to an embodiment;

FIG. 15 shows a block diagram of a nonvolatile memory according to an embodiment;

FIG. 16 shows a block diagram of an integrated circuit according to an embodiment; and

FIG. 17 shows a block diagram of a storage device according to an embodiment.

### DETAILED DESCRIPTION

In the following detailed description, only certain embodiments of the present disclosure have been shown and described, simply by way of illustration. As those skilled in the art would realize, the described embodiments may be modified in various different ways, all without departing from the spirit or scope of the present disclosure.

Accordingly, the drawings and description are to be regarded as illustrative in nature and not restrictive. Like reference numerals designate like elements throughout the specification. In the flowcharts described with reference to the drawings in this specification, the operation order may be changed, various operations may be merged, certain operations may be divided, and certain operations may not be performed.

An expression recited in the singular may be construed as singular or plural unless the expression “one”, “single”, etc., is used. Terms including ordinal numbers such as first, second, and the like, will be used only to describe various components, and are not to be interpreted as limiting these components. The terms may only be used to differentiate one component from others.

Terms such as “unit”, “module”, “member”, and “block” may be embodied as hardware or software. According to embodiments, a plurality of “unit”, “module”, “member”, and “block” may be implemented as a single component or a single “unit”, “module”, “member”, and “block” may include a plurality of components.

It will be understood that when an element is referred to as being “connected” with or to another element, it can be directly or indirectly connected to the other element, wherein the indirect connection includes “connection via a wireless communication network”.

Also, when a part “includes” or “comprises” an element, unless there is a particular description contrary thereto, the part may further include other elements, not excluding the other elements.

Herein, the expression “at least one of a, b or c” indicates “only a,” “only b,” “only c,” “both a and b,” “both a and c,” “both b and c,” or “all of a, b, and c.”

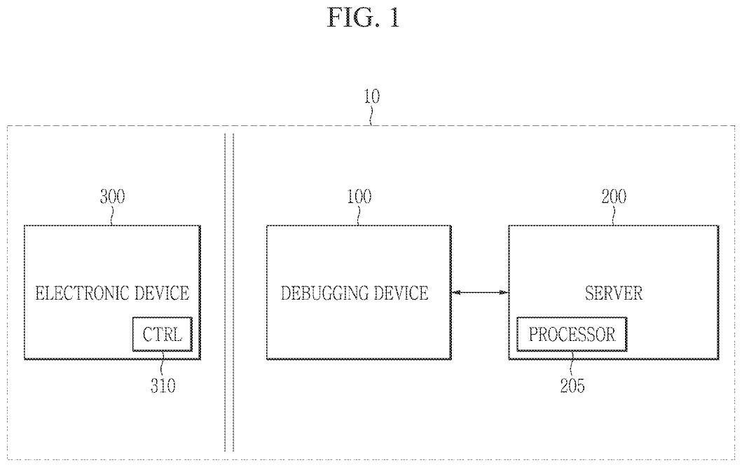

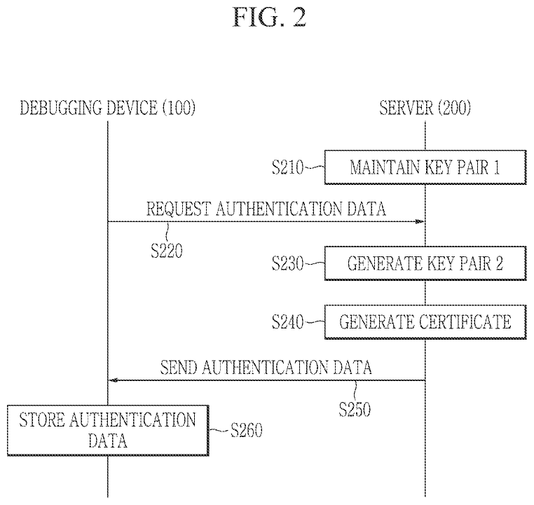

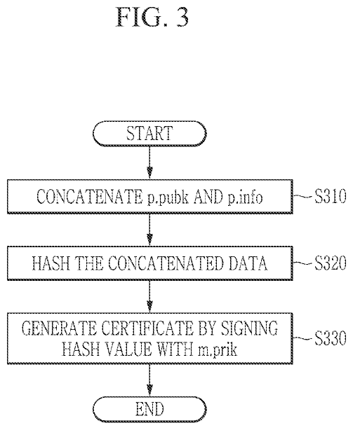

FIG. 1 shows a block diagram of an authentication system according to an embodiment, FIG. 2 shows a flowchart of operations of a debugging device and a server according to an embodiment, and FIG. 3 shows a flowchart of a method for generating a certificate according to an embodiment.

Referring to FIG. 1, the authentication system 10 includes a debugging device (or a debugger) 100, a server 200, and an electronic device 300. The authentication system 10 may perform an authentication process for the debugging device 100 to debug the electronic device 300. That is, the debugging device 100 may debug the electronic device 300. For example, when a problem is generated to the electronic device 300, the debugging device 100 may be connected to the electronic device 300, and may debug the electronic device 300.

The electronic device 300 may be included in user devices such as servers, data centers, artificial intelligence (AI) devices, personal computers, laptop computers, media reproducers, or digital cameras, or automotive devices such as GPS, black boxes, or electronic vehicle devices. In another way, the electronic device 300 may be a mobile system such as a mobile phone, a smartphone, a tablet personal computer, a wearable device, a healthcare device, or an Internet of Things (IoT) device. In an embodiment, the electronic device 300 is a data center including storage devices (e.g., a solid-state drive (SSD) device), and the debugging device 100 may debug at least one of storage devices.

The server 200 may be an authentication server managed by a manufacturer of the electronic device 300. To debug the electronic device 300, the debugging device 100 may have to obtain proper authentication data of the electronic device 300 from the server 200. However, the debugging device 100 may fail to communicate with the server 200 in a place where the electronic device 300 is arranged. Hence, the debugging device 100 may communicate with the server 200 before being connected to the electronic device 300 (or before entering the place where the electronic device 300 is arranged). The debugging device 100 may request authentication data for debugging the electronic device 300 to the server 200. Two vertical lines in FIG. 1 show that the electronic device 300 does not communicate with the debugging device 100 or the server 200 when the debugging device 100 communicates with the server 200.

The server 200 may generate authentication data in response to the request from the debugging device 100. The server 200 may store a key pair for authenticating the electronic device 300. For example, the key pair for authentication may include a master public key and a master private key. The server 200 may include a processor 205 for generating authentication data. The processor 205 may generate authentication data based on the key pair.

Referring to FIG. 2, the server 200 may maintain the first key pair (S210). The first key pair may include a master public key and a master private key. When the server 200 maintains the first key pair, it may mean that the first key pair is stored in the storage device of the server 200. The server 200 may generate the first key pair by using a predetermined encryption algorithm, and may store the first key pair.

The debugging device 100 may request authentication data to the server 200 (S220). The debugging device 100 may transmit product information on the electronic device (e.g., the electronic device 300 of FIG. 1) to be debugged to the server 200. For example, the product information may include identification and version information. The identification may show a proper number of the electronic device. The version information may indicate version information of the system currently driven in the electronic device. The version information may include an anti-rollback value that is not returned when the version is updated. The version of the system of the electronic device may be updated because of security, etc.

In an embodiment, the debugging device 100 may log in to the server 200 in advance to the request of authentication data. The server 200 may allow the log-in of the debugging device 100 through a predetermined authentication process. That is, the server 200 may allow an access when the debugging device 100 passes the authentication process, and it may prevent the access when the debugging device 100 fails to pass the authentication process.

The server 200 may generate a second key pair (S230). The second key pair may include a product public key and a product private key. The server 200 may generate the second key pair by using the same encryption algorithm used when generating the first key pair.

The server 200 may generate a certificate (S240). The electronic device to be debugged may use the certificate to verify the debugging device 100. The server 200 may generate the certificate by using at least one of the first key pair, the second key pair, and the product information.

Referring to FIG. 1 and FIG. 3, the processor 205 of the server 200 may generate a certificate. The processor 205 may concatenate a product public key (p.pubk) and product information (p.info) (S310). The product information (p.info) may include at least one of the identification and the version information. In an embodiment, the processor 205 may perform a concatenation in order of the product public key (p.pubk) and the product information (p.info), and the embodiment is not limited thereto, and they may be concatenated in reverse order. In an embodiment, the processor 205 may perform a concatenation in order of the identification from among the product public key (p.pubk) and the product information (p.info), and in order of the version information from among the product information (p.info), and the embodiment is not limited thereto. The processor 205 may share the order for concatenating the product public key (p.pubk) and the product information (p.info) with the electronic device 300 of FIG. 1. In an embodiment, the processor 205 may transmit the information on the order to the electronic device 300 through the debugging device 100. The information on the order may include the order, and a delimiter between concatenation. In an embodiment, the debugging device 100 may instruct an order to the processor 205, and may transmit the order to the electronic device 300.

The processor 205 may hash concatenated data (S320). The processor 205 may generate a hash value of the concatenated data by using a hash algorithm. In an embodiment, the processor 205 may generate the hash value by hashing the concatenated data in order of the product information (p.info) and the product public key (p.pubk). In an embodiment, the processor 205 may generate the hash value by hashing the concatenated data in order of the product public key (p.pubk), the identification, and the version information.

The processor 205 may generate the certificate by signing the hash value by use of the master private key (m.prik) (S330). The certificate signed by using the master private key (m.prik) may be decrypted by using the master public key.

Referring to FIG. 2, the server 200 may transmit the authentication data to the debugging device 100 (S250). The authentication data may include the master public key of the first key pair, the second key pair, and the certificate. That is, the server 200 may transmit the master public key, the product public key, the product private key, and the certificate to the debugging device 100.

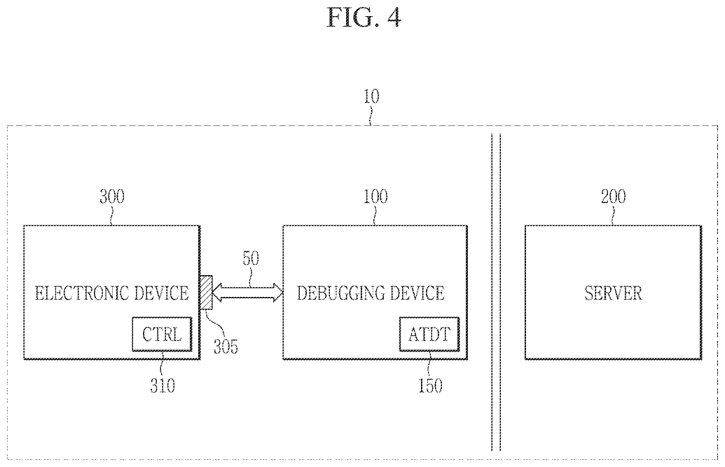

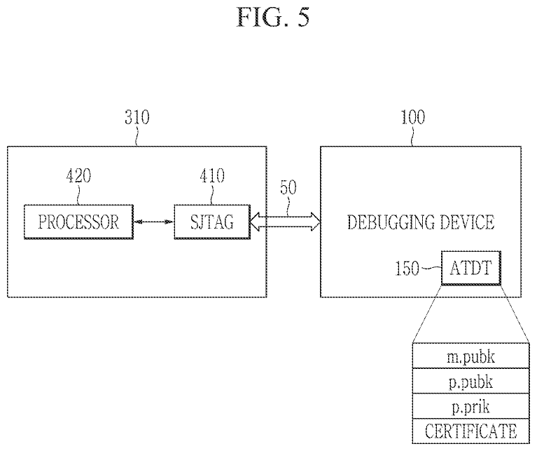

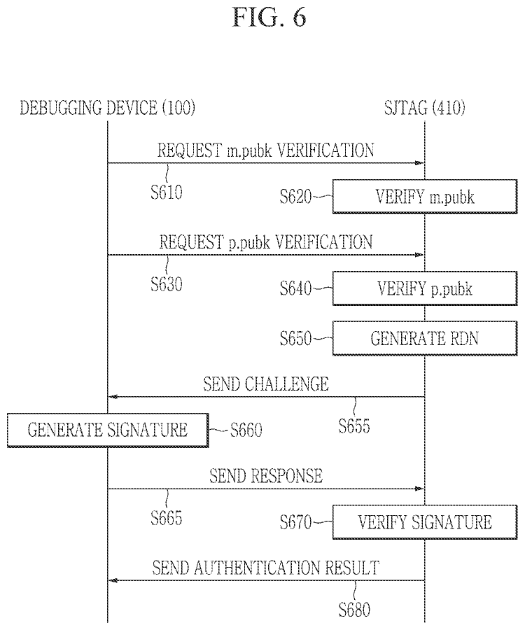

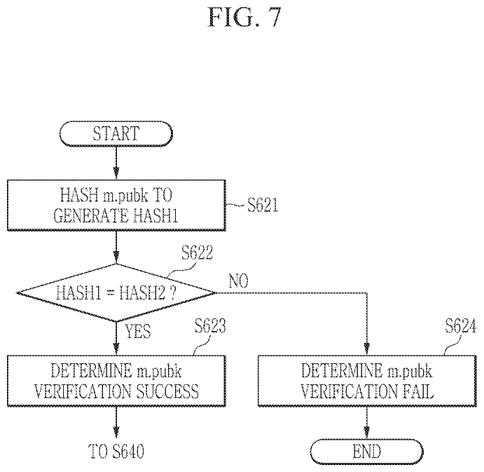

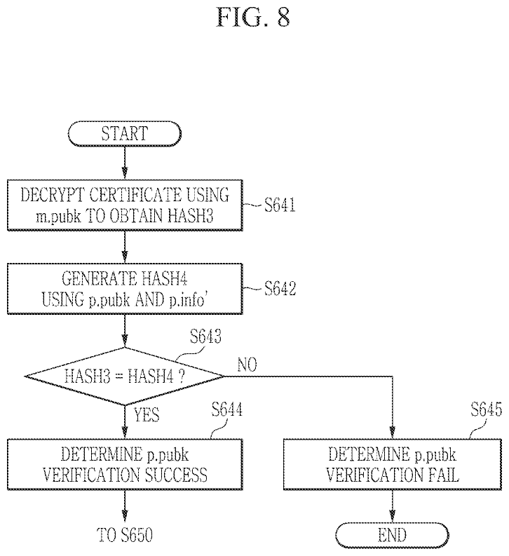

The debugging device 100 may store the authentication data (S260). The debugging device 100 may release the concatenation to the server 200 when storing the authentication data. The debugging device 100 may request a debugging to the electronic device to be debugged by using the authentication data. FIG. 4 shows a block diagram of an authentication system according to an embodiment, FIG. 5 shows a block diagram on operations of a debugging device and a controller according to an embodiment, FIG. 6 shows a flowchart of operations of a debugging device and an authentication device according to an embodiment, and FIG. 7 and FIG. 8 shows a flowchart of an authentication method by an authentication device according to an embodiment.

Referring to FIG. 4, the authentication system 10 may include a debugging device 100, a server 200, and an electronic device 300. The description on the authentication system 10 of FIG. 1 is identically applied to the authentication system 10 of FIG. 4 so no repeated descriptions will be provided. The debugging device 100 may store authentication data (ATDT) 150. The debugging device 100 may obtain the authentication data 150 from the server 200 before accessing the electronic device 300. The debugging device 100 may be connected to the electronic device 300, and may request a debugging to the electronic device 300 by using the authentication data 150. The debugging device 100 may fail to communicate with the server 200 in the place where the electronic device 300 is arranged. Two vertical lines of FIG. 4 indicate that the server 200 does not communicate with the debugging device 100 or the electronic device 300 when the debugging device 100 communicates with the electronic device 300.

The debugging device 100 may be connected to the electronic device 300 by using a debugging interface 50. The debugging interface 50 is a debugging protocol, and it may use a method such as the joint test action group (JTAG) method or the serial wire debug (SWD) method. The electronic device 300 may include a port 305 for supporting the debugging interface 50. In an embodiment, the port 305 may include pins for supporting the JTAG method, such as a data input pin (TDI), a data output pin (TDO), a test clock signal pin (TCK), a test mode switching signal pin (TMS), a reset pin (TRST), and a ground.

The electronic device 300 may include a controller (CTRL) 310 for controlling a general operation of the electronic device 300. In an embodiment, the controller 310 may be realized with a system on chip (SoC). The controller 310 may receive the authentication data 150 from the debugging device 100, and may verify the authentication data 150. The controller 310 may allow a debugging to the debugging device 100 according to a verification result. For example, the controller 310 may allow a debugging to the debugging device 100 when the verification is successful, and it may prevent the debugging to the debugging device 100 when the verification failed.

The controller 310 may include a sub-controller for controlling a peripheral device of the electronic device 300. In an embodiment, the electronic device 300 may include a memory device, and the controller 310 may include a memory controller for controlling the memory device (e.g., a volatile memory such as a dynamic random access memory (DRAM)). In an embodiment, the electronic device 300 may include a storage device (e.g., a nonvolatile memory such as a NAND flash), and the controller 310 may include a storage controller for controlling the storage device.

Referring to FIG. 5, the controller 310 may include an authentication device (SJTAG) 410 and a processor 420. The authentication device 410 may verify the authentication data 150 of the debugging device 100. The authentication data 150 may include a master public key (m.pubk), a product public key (p.pubk), a product private key (p.prik), and a certificate. The processor 420 may be realized with at least one of various types of processors such as a central processing unit (CPU), a graphics processing unit (GPU), a neural processing unit (NPU), a data processing unit (DPU), or an application processor (AP). In an embodiment, the processor 420 may be realized with a single core processor or a multi-core processor.

The authentication device 410 may receive the authentication data 150 from the debugging device 100. For example, the authentication device 410 may receive the authentication data 150 through the debugging interface 50. The authentication device 410 may verify the authentication data 150. The authentication device 410 may output debugging enable signals to the processor 420 according to a verification result. For example, the authentication device 410 may output a debugging enable signal when the verification is successful, and it may not output the debugging enable signal when the verification failed. The debugging enable signal may allow the debugging device 100 to debug the processor 420. When the processor 420 receives the debugging enable signal, the debugging device 100 may debug the processor 420. That is, when the processor 420 receives the debugging enable signal, the debugging device 100 may perform a debugging based on a debugging signal of the processor 420. When the processor 420 does not receive the debugging enable signal, the debugging device 100 may fail to debug the processor 420.

Referring to FIG. 5 and FIG. 6, the debugging device 100 may request the authentication device 410 to verify the authentication data 150. The debugging device 100 may request the authentication device 410 to verify the master public key (m.pubk) from among the authentication data 150 (S610). The debugging device 100 may transmit the master public key (m.pubk) to the authentication device 410 through the debugging interface 50.

The authentication device 410 may verify the master public key (m.pubk) (S620). The authentication device 410 may verify whether the master public key (m.pubk) of the debugging device 100 is obtained from the server 200 of FIG. 4. The authentication device 410 may store a verification value for verifying the master public key (m.pubk). The verification value may include information on the master public key of the server 200. For example, the verification value may be a hash value of the master public key of the server 200. The authentication device 410 may include a nonvolatile memory for storing the verification value.

FIG. 7 shows a method for an authentication device 410 according to an embodiment to verify the master public key (m.pubk). Referring to FIG. 7, the authentication device 410 may generate a hash value (HASH1) by applying a hash algorithm to the master public key (m.pubk) (S621).

The authentication device 410 may determine whether the hash value (HASH1) is equal to the hash value (HASH2) (S622). The hash value (HASH2) is a verification value for verifying the hash value (HASH1), and it may be stored in a nonvolatile memory of the authentication device 410. The authentication device 410 may generate the hash value (HASH2) by using a hash algorithm to the master public key of the server and may store the same. The hash algorithms used in generating the hash value (HASH1) and the hash value (HASH2) may be the same.

The authentication device 410 may determine that the verification of the master public key (m.pubk) is successful when the hash value (HASH1) is equal to the hash value (HASH2) (S623). The authentication device 410 may store the master public key (m.pubk). For example, the authentication device 410 may include a memory for storing the master public key (m.pubk). The memory may be realized with a volatile memory, and the embodiment is not limited thereto. When the verification of the master public key (m.pubk) is successful, the authentication device 410 may proceed to S640 and may perform next verification.

When the hash value (HASH1) is not equal to the hash value (HASH2), the authentication device 410 may determine that the verification of the master public key (m.pubk) failed (S624). When the verification of the master public key (m.pubk) is a failure, the authentication device 410 may finish the verification of the authentication data 150.

Referring to FIG. 5 and FIG. 6, the debugging device 100 may request the authentication device 410 to verify the product public key (p.pubk) (S630). The debugging device 100 may transmit the product public key (p.pubk) and the certificate to the authentication device 410 through the debugging interface 50. The certificate may be used to verify the product public key (p.pubk).

The authentication device 410 may verify the product public key (p.pubk) (S640). When the verification of the master public key (m.pubk) is successful in the S620, the authentication device 410 may verify the product public key (p.pubk). The authentication device 410 may verify whether the product public key (p.pubk) of the debugging device 100 is obtained from the server 200 of FIG. 4. The nonvolatile memory of the authentication device 410 may further store product information for verifying the product public key (p.pubk). The product information may include identification, version information, etc.

FIG. 8 shows a method for the authentication device 410 according to an embodiment to verify the product public key (p.pubk). Referring to FIG. 8, the authentication device 410 may decrypt the certificate by using the master public key (m.pubk) and may obtain a hash value (HASH3) (S641). As the processor 205 of FIG. 1 has signed by using the master private key (m.prik), the certificate may be decrypted by the master public key (m.pubk) forming the first key pair with the master private key (m.prik). The master public key (m.pubk) may be stored in the memory of the authentication device 410 after the S620. The hash value (HASH3) may be generated by using the hash algorithm to the product public key (p.pubk) and the product information (p.info) by the processor 205 of FIG. 1.

The authentication device 410 may generate a hash value (HASH4) by using the product public key (p.pubk) and the product information (p.info′) (S642). The nonvolatile memory of the authentication device 410 may further store the product information (p.info′), and the product information (p.info′) may have a same value as the product information (p.info) of FIG. 3. The authentication device 410 may generate concatenated data by concatenating the product public key (p.pubk) and the product information (p.info′). The order for the authentication device 410 to concatenate the product public key (p.pubk) and the product information (p.info′) may be equivalent to the order for the processor 205 to concatenate the product public key (p.pubk) and the product information (p.info) in FIG. 3. The authentication device 410 may generate the hash value (HASH4) by using the hash algorithm to the concatenated data.

The authentication device 410 may determine whether the hash value (HASH3) is equivalent to the hash value (HASH4) (S643). The hash algorithm used in generating the hash value (HASH4) may be identical with the hash algorithm used in generating the hash value (HASH3). Hence, when the product information (p.info′) matches to the product information (p.info), the hash value (HASH3) may match to the hash value (HASH4).

When the hash value (HASH3) matches to the hash value (HASH4), the authentication device 410 may determine that the verification of the product public key (p.pubk) is successful (S644). In an embodiment, the authentication device 410 may determine, together with the product public key (p.pubk), that the verification of the certificate is successful. The authentication device 410 may store the product public key (p.pubk) in the memory when the hash value (HASH3) matches to the hash value (HASH4). The memory may be realized with a volatile memory, and the embodiment is not limited thereto. The authentication device 410 may proceed to S650 and may perform a next verification when the verification of the product public key (p.pubk) is successful.

When the hash value (HASH3) does not matche to the hash value (HASH4), the authentication device 410 may determine that the verification of the product public key (p.pubk) failed (S645). When the verification of the product public key (p.pubk) is a failure, the authentication device 410 may finish the verification of the authentication data 150.

Referring to FIG. 5 and FIG. 6, when the verification of the product public key (p.pubk) is successful, the authentication device 410 may perform challenge-response authentication. The authentication device 410 may generate a random number (RDN) (S650). The authentication device 410 may generate the random number (RDN) by using a true random number generator (TRNG). In an embodiment, the authentication device 410 may generate the random number (RDN) by combining the true random number generator and a pseudo random number generator (PRNG). The authentication device 410 may store the random number (RDN) in the memory. The authentication device 410 may transmit the random number (RDN) to the debugging device 100 as a challenge of the challenge-response authentication (S650). The debugging device 100 may receive the random number (RDN) that is a challenge.

The debugging device 100 may generate a signature by using the random number (RDN) (S660). For example, the debugging device 100 may perform a signing to the random number (RDN) by using the product private key (p.prik) of the authentication data 150. In an embodiment, the debugging device 100 may generate the signature based on the random number (RDN) and debugging information. For example, the debugging device 100 may generate concatenated data by concatenating the random number (RDN) and the debugging information. The debugging device 100 may generate the concatenated data in order of the random number (RDN) and the debugging information, and the embodiment is not limited thereto. The debugging device 100 may perform a signing to the concatenated data by using the product private key (p.prik). The signature using the product private key (p.prik) may be decrypted by the product public key (p.pubk) forming the second key pair with the product private key (p.prik).

The debugging device 100 may transmit the signature to the authentication device 410 as a response to the challenge-response authentication (S665). The authentication device 410 may receive the signature that is a response.

The authentication device 410 may verify the signature (S670). The authentication device 410 may decrypt the signature by using the product public key (p.pubk) of the authentication data 150, and may obtain response data. The authentication device 410 may compare the response data and the random number (RDN) stored in the memory. The authentication device 410 may determine that the verification of the signature is successful when the response data matches to the random number (RDN). The authentication device 410 may determine that the verification of the signature failed when the response data do not match to the random number (RDN). In an embodiment, the authentication device 410 may further obtain debugging information together with decryption result response data. When the authentication result is successful, the authentication device 410 may transmit the debugging information to the processor 420.

The authentication device 410 may transmit an authentication result to the debugging device 100 (S670). The debugging device 100 may not perform a debugging when the authentication result is a failure. The debugging device 100 may perform a debugging when the authentication result is successful. The authentication device 410 may output a debugging enable signal to the processor 420 when the authentication result is successful. In an embodiment, the debugging device 100 may transmit debugging information to the processor 420 when the authentication result is successful. The processor 420 may perform a debugging based on the debugging enable signal and the debugging information.

As described, when the authentication system 10 may not communicate with the server 200 in the place where the electronic device 300 is arranged, and the server 200 does not submit the master private key (m.prik), the debugging device 100 may pass authentication of the authentication device 410 by using the certificate, the master public key (m.pubk), the product public key (p.pubk), and the product private key (p.prik). When at least one of the certificate, the master public key (m.pubk), the product public key (p.pubk), and the product private key (p.prik) is leaked, the authentication device 410 may maintain the security.

For example, the electronic device 300 having different identifications for respective clients may be provided. In this instance, when at least one of the certificate, the master public key (m.pubk), the product public key (p.pubk), and the product private key (p.prik) of one client company is leaked, the electronic device of another client company as a different identification so it may not pass the authentication of the authentication device. Further, the client company of which at least one of the certificate, the master public key (m.pubk), the product public key (p.pubk), and the product private key (p.prik) is leaked may maintain the security by updating the version information. The version information updated once may have an anti-rollback value that is not returned.

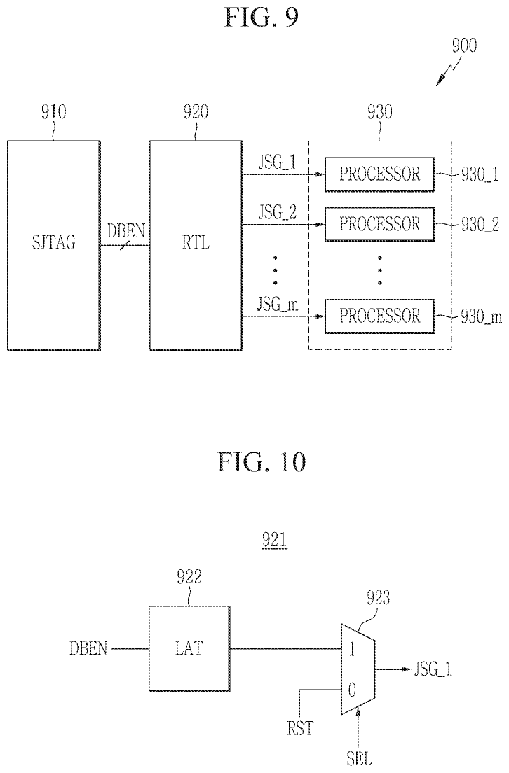

FIG. 9 shows a block diagram of operations of an authentication device, a retention logic, and a processor according to an embodiment, and FIG. 10 shows a circuit diagram of an operation of a retention logic according to an embodiment.

Referring to FIG. 9, the authentication device 900 may include an authentication device (e.g., a Secure JTAG (SJTAG)) 910, a retention logic (RTL) 920, and processors 930. The processors 930 may include first to m-th processors 930_1 to 930_m. Here, m may be an integer that is greater than 1.

The authentication device 910 may output a debugging enable signal DBEN according to an authentication result. The debugging enable signal DBEN may include information on the processor to be debugged from among the processors 930. For example, the authentication device 910 may output the debugging enable signal DBEN when the authentication of the debugging device is successful, and it may not output the debugging enable signal DBEN when the authentication of the debugging device is a failure.

The retention logic 920 may receive the debugging enable signal DBEN from the authentication device 910. The retention logic 920 may include retention circuits for outputting JTAG signals JSG_1 to JSG_m based on the debugging enable signal DBEN. The respective retention circuits may include a latch circuit and a selecting circuit.

Referring to FIG. 9 and FIG. 10, the first retention circuit 921 may include a latch circuit 922 and a selecting circuit 923. The latch circuit 922 may store an authentication result in response to the debugging enable signal DBEN. For example, the debugging enable signal DBEN may instruct an authentication success on the processor 930_1, and the latch circuit 922 may store the authentication success instruction on the processor 930_1. The latch circuit 922 may transmit an authentication result on the selecting circuit 923.

The selecting circuit 923 may receive a selection signal (SEL), a reset signal (RST), and an authentication result. The selecting circuit 923 may output the first JTAG signal JSG_1 to the processor 930_1. The selecting circuit 923 may selectively provide the authentication result or the reset signal (RST) to the processor 930_1 according to the selection signal (SEL). The selecting circuit 923 may be realized with a multiplexer.

In an embodiment, the retention logic 920 may include a plurality of circuits having the same structure as the first retention circuit 921. For example, the retention logic 920 may include retention circuits corresponding to the number of the processors 930. The processors 930 may include m-numbered processors, and the retention logic 920 may include m-numbered latch circuits and m-numbered selecting circuits.

The retention logic 920 may store an authentication result in response to the debugging enable signal DBEN, and may provide the JTAG signals JSG_1 to JSG_m to the processors 930. For example, the first JTAG signal JSG_1 may be provided to the first processor 930_1, the second JTAG signal JSG_2 may be provided to the second processor 930_2, and the m-th JTAG signal JSG_m may be provided to the m-th processor 930_m. The processors 930 may perform a debugging operation in response to the JTAG signals JSG_1 to JSG_m.

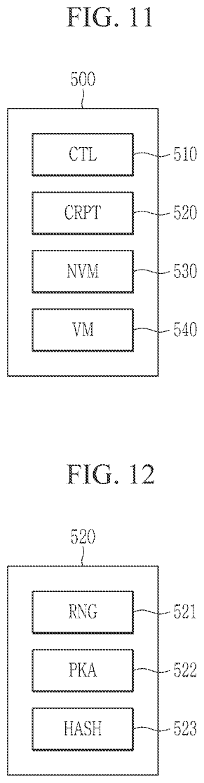

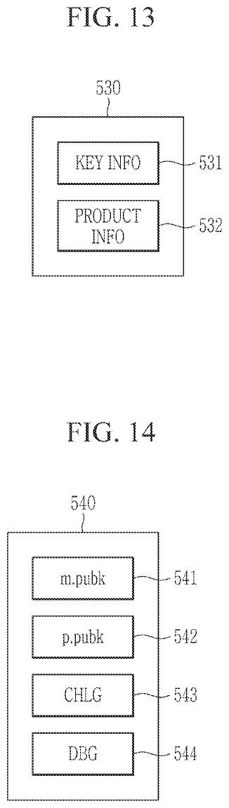

FIG. 11 shows a block diagram of an authentication device according to an embodiment, FIG. 12 shows a block diagram of an encryption engine according to an embodiment, FIG. 13 shows an operation of a nonvolatile memory according to an embodiment, and FIG. 14 shows an operation of a volatile memory according to an embodiment.

Referring to FIG. 11, the authentication device 500 may include a control logic (i.e., controller) (CTL) 510, an encryption engine (CRPT) 520, a nonvolatile memory (NVM) 530, and a volatile memory (VM) 540.

The control logic 510 may control the general operation of the authentication device 500. The control logic 510 may control the encryption engine 520, the nonvolatile memory 530, and the volatile memory 540. For example, the control logic 510 may perform an encryption or a decryption by using the encryption engine 520. The control logic 510 may read the data stored in the nonvolatile memory 530. The data read from the nonvolatile memory 530 may be transmitted to the encryption engine 520 and may be used in encryption. The control logic 510 may store the data of which verification is successful in the volatile memory 540. The encryption engine 520 may perform encryption and decryption. For example, the encryption engine 520 may perform encryption and decryption to verify the debugging device and the data received from the debugging device. The encryption engine 520 may include constituent elements for encryption and constituent elements for decryption. Referring to FIG. 11 and FIG. 12, the encryption engine 520 may include a random number generator (RNG) 521, a public key accelerator (PKA) 522, and a hash algorithm circuit (HASH) 523.

The random number generator 521 may generate a random number. The random number generator 521 may include a true random number generator (TRNG). The random number generator 521 may generate a random number by using the true random number generator (TRNG). In an embodiment, the random number generator 521 may further include a pseudo random number generator (PRNG). The random number generator 521 may generate the random number by combining the true random number generator (TRNG) and the pseudo random number generator (PRNG). For example, the true random number generator (TRNG) may generate a true random number, and the pseudo random number generator (PRNG) may generate a random number based on the true random number generated by the true random number generator (TRNG). The random number generated by the random number generator 521 may be used in the challenge-response authentication of the debugging device.

The public key accelerator 522 may decrypt the data received from the debugging device. The debugging device may transmit the data generated by using the master private key or the product private key to the authentication device 500. The public key accelerator 522 may decrypt the data by using the master public key or the product public key. The volatile memory 540 may store the master public key and the product public key. For example, the debugging device may transmit the certificate generated by using the master private key to the authentication device 500. The authentication server may generate the certificate by using the master private key. The public key accelerator 522 may decrypt the certificate by using the master public key and may obtain a first decryption value.

The debugging device may generate a response by using the product private key and may transmit the response to the authentication device 500. The response may correspond to the challenge of the challenge-response authentication requested by the authentication device 500. The public key accelerator 522 may decrypt the response by using the product public key and may obtain a second decryption value. The first and second decryption values by decrypting the public key accelerator 522 may be used when the control logic 510 performs verification.

The hash algorithm circuit 523 may generate a hash value by using the hash algorithm. For example, the hash algorithm circuit 523 may generate a first hash value of the master public key received from the debugging device. The hash algorithm circuit 523 may generate concatenated data by concatenating the product information of the nonvolatile memory 530 and the product public key received from the debugging device and may generate a second hash value of the concatenated data. Further, the hash algorithm circuit 523 may generate a third hash value of the master public key of the authentication server. The third hash value may be stored in the nonvolatile memory 530. The hash values generated by the hash algorithm circuit 523 may be used when the control logic 510 performs a verification.

Referring to FIG. 11 and FIG. 13, the nonvolatile memory 530 may store data for verifying the debugging device and the data received from the debugging device. For example, the nonvolatile memory 530 may store key information 531 and product information 532. The key information 531 may be information on the key for the authentication server to manage authentication device 500. The authentication server may store a key pair (public key and private key) on the authentication device 500. The nonvolatile memory 530 may store information on the master public key of the key pair of the authentication server. For example, the hash algorithm circuit 523 of FIG. 12 may generate a third hash value of the master public key of the authentication server, and the nonvolatile memory 530 may store a third hash value of the master public key. The third hash value stored by the nonvolatile memory 530 may be used in verifying the master public key transmitted by the debugging device. For example, the hash algorithm circuit 523 may generate a first hash value of the master public key transmitted by the debugging device. The control logic 510 may verify the master public key transmitted by the debugging device by comparing the third hash value of the nonvolatile memory 530 and the first hash value generated by the hash algorithm circuit 523.

The product information 532 may be product information (or product information of the electronic device) of the authentication device 500. For example, the product information 532 may include identification and version information. The product information 532 may be used in verifying the product public key transmitted by the debugging device. The hash algorithm circuit 523 of FIG. 12 may generate concatenated data by concatenating the product information 532 and the product public key transmitted by the debugging device, and may generate a second hash value of the concatenated data. The control logic 510 may verify the product public key transmitted by the debugging device by comparing the second hash value and the decrypted certificate.

Referring to FIG. 11 and FIG. 14, the volatile memory 540 may store the data of which the verification is successful. The control logic 510 may store the data in the volatile memory 540 when the verification of the corresponding data received from the debugging device is successful. For example, the control logic 510 may compare the first hash value generated based on the master public key (m.pubk) received from the debugging device and the third hash value stored in the nonvolatile memory 530. The control logic 510 may determine the verification of the master public key (m.pubk) to be successful when the first hash value matches to the third hash value. The control logic 510 may store the master public key (m.pubk) in the first memory region 541.

The control logic 510 may compare the second hash value generated based on the product information of the nonvolatile memory 530 and the product public key (p.pubk) received from the debugging device, and the first decryption value obtained by the public key accelerator 522 of FIG. 12. The authentication server may generate a fourth hash value by using a hash algorithm to the product public key and the product information, and may sign to the fourth hash value by using the master private key to generate a certificate. Therefore, the first decryption value obtained by the public key accelerator 522 may be identical to the fourth hash value. The control logic 510 may determine the verification of the product public key (p.pubk) to be successful when the second hash value matches to the fourth hash value. The control logic 510 may store the product public key (p.pubk) in the second memory region 542.

The control logic 510 may store a random number (CHLG) generated by the random number generator 521 of FIG. 12 in the third memory region 543. The control logic 510 may compare the random number (CHLG) and the second decryption value obtained by the public key accelerator 522 of FIG. 12. The control logic 510 may determine the challenge-response authentication to be successful when the random number (CHLG) matches to the second decryption value. In an embodiment, the response data of the debugging device may include debugging information (DBG). The control logic 510 may store debugging information (DBG) in the fourth memory region 544. The control logic 510 may transmit the debugging information (DBG) to the processor, and the processor may perform a debugging based on the debugging information (DBG).

In an embodiment, the encryption engine 520 may further include a random number generator 521, a public key accelerator 522, and a finite state machine (FSM) circuit for sequentially performing operations of the hash algorithm circuit 523. The FSM circuit may control the operations of the random number generator 521, the public key accelerator 522, and the hash algorithm circuit 523 so that the authentication device 410 may perform authentication in order of S620, S640, S650, and S670 in a flowchart of FIG. 6. For example, the FSM circuit may control the random number generator 521, the public key accelerator 522, and the hash algorithm circuit 523 so that the hash algorithm circuit 523 may generate the first hash value of the master public key of the debugging device, the public key accelerator 522 may decrypt the certificate, the hash algorithm circuit 523 may generate the product information and the second hash value of the product public key, the random number generator 521 may generate the random number, and the public key accelerator 522 may decrypt the response in order.

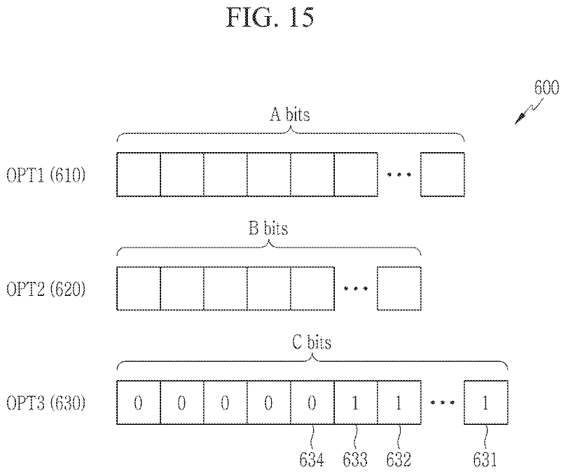

FIG. 15 shows a block diagram of a nonvolatile memory according to an embodiment.

Referring to FIG. 15, the nonvolatile memory 600 may include one time programmable (OTP) memories 610 to 630. One space of the OTP memories 610 to 630 may indicate one memory cell, and the one memory cell may store 1-bit data. Regarding the OTP memories 610 to 630, in an earlier stage, the entire memory cells may maintain ‘0’ bit, and the memory cell programmed once with ‘1’ bit may maintain ‘1’ bit.

The first OTP memory 610 may store A bits, and may store key information 531 of FIG. 13. The second OTP memory 620 may store B bits, and may store the identification from among the product information 532 of FIG. 13. The third OTP memory 630 may store C bits, and may store the version information from among the product information 532 of FIG. 13. In this instance, A, B, and C are integers that are greater than 1, and depending on embodiments, they may all be the same number, two of them may be the same number, or they may all be different.

As the identification from among the key information 531 and the product information 532 of FIG. 13 is not changed when set once, the first OTP memory 610 and the second OTP memory 620 may not change the programmed data but may maintain the same unless there are specific reasons. On the contrary, a version of the currently driven system of the electronic device including the nonvolatile memory 600 may be updated because of reasons such as the security. The third OTP memory 630 may update version information according to updates of the system. The control logic 510 of FIG. 11 instructs the third OTP memory 630 to update the version information, and the third OTP memory 630 may update the version information based on the instruction of the control logic 510. For example, referring to FIG. 15, the third OTP memory 630 may store ‘1’ bit in the memory cells 631 to 633 corresponding to first version information of the current system. When the electronic device drives the system of the updated second version information, it may program ‘1’ bit to the memory cell 634. The order for the OTP memories 610 to 630 to program the memory cells may be performed in many ways depending on embodiments.

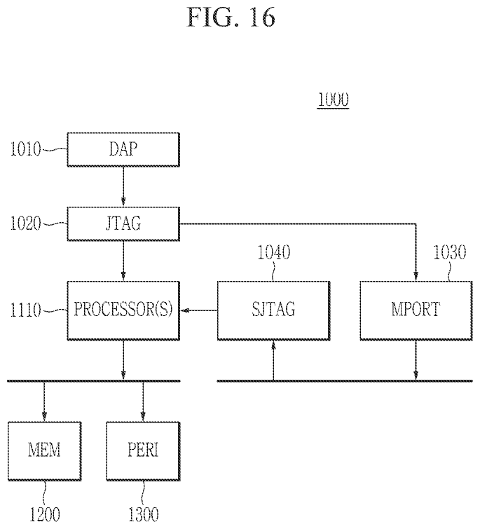

FIG. 16 shows a block diagram of an integrated circuit according to an embodiment.

Referring to FIG. 16, the integrated circuit 1000 includes a processor 1100, a memory 1200, a peripheral circuit 1300, a debugging access port (DAP) 1010, a JTAG 1020, a master port (MPORT) 1030, and an authentication device (SJTAG) 1040. The processor 1100 may include processing units. A user may debug the integrated circuit 1300 through the DAP 1010. The JTAG 1020 may debug the internal elements 1100, 1200, and 1300 of the integrated circuit 1000 through the master port 1030.

The authentication device 1040 may use information owned by a legal user as a request for performing an authentication protocol between the user and the JATG 1020. The authentication device 1040 may determine access states of the respective processing units to the JTAG 1020, access states of the memory 120, and access states of the peripheral circuit 1300 based on access control information input by the user after the authentication protocol.

A content on the authentication device described with reference to FIG. 1 to FIG. 15 may be applied to the authentication device 1040. That is, the authentication device 1040 verifies the master public key, the product public key, the product private key, and the certificate received through the DAP 1010, the JTAG 1020, and the master port 1030, and it may allow debugging when the verification is successful.

The integrated circuit 1000 may reinforce the security by performing a safe debugging.

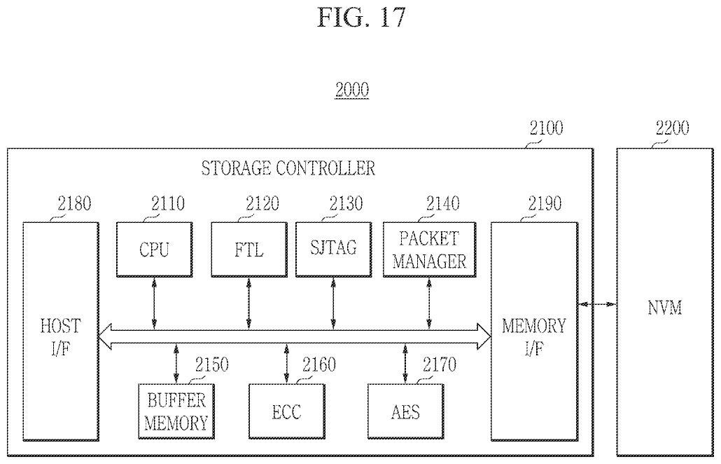

FIG. 17 shows a block diagram of a storage device according to an embodiment.

Referring to FIG. 17, the storage device 2000 may store data. The storage device 2000 may be arranged in the computing system and may be operable based on the instruction of a host. The computing system may include user devices such as a server, a data center, an artificial intelligence device, a personal computer, a laptop computer, a media player, a digital camera or vehicle equipment such as a GPS, a black box, or an electronic vehicle device. Alternatively, the computing system may include mobile systems such as a portable communication terminal, a smartphone, a tablet PC, a wearable device, a healthcare device or an Internet of things device.

Regarding the computing system, the host may communicate with the storage device 2000 through various types of interfaces. The host may request data processing operations, for example, a data read operation, a data write (or program) operation, and a data erase operation from the storage device 2000. For example, the host may be a CPU, a GPU, a microprocessor, or an AP.

The storage device 2000 may include a storage controller 2100 and a nonvolatile memory (NVM) 2200. The storage device 2000 may include storage media for storing data according to a request from the host. For example, the storage device 2000 may be realized with a solid-state drive (SSD), an embedded multi-media card (eMMC), a universal flash storage (UFS), a compact flash (CF), a secure digital (SD) device, a micro-SD device, a mini-SD device, an extreme digital (xD) device, or a memory stick.

When the storage device 2000 is an SSD, the storage device 2000 may follow a nonvolatile memory express (NVMe) standard. When the storage device 2000 is an embedded memory or an external memory, the storage device 2000 may follow a UFS standard or an eMMC standard. The host and the storage device 2000 may generate packets following the adopted standard protocol and may transmit the same.

When the nonvolatile memory 2200 of the storage device 2000 includes a flash memory, the flash memory may include a two-dimensional (2D) NAND memory array or a three-dimensional (3D) NAND memory array. For another example, the nonvolatile memory 2200 of the storage device 2000 may include various types of memories. For example, the nonvolatile memory 2200 may use various types of memories such as a magnetoresistive random-access memory (MRAM), a spin-transfer torque magnetic random-access memory (STT-RAM), a conductive bridging random-access memory (CBRAM), a ferroelectric random-access memory (FeRAM), a phase-change random-access memory (PRAM), or a resistive random-access memory (RRAM).

The storage controller 2100 may include a host interface 2180, a memory interface 2190, and a CPU 2110. The storage controller 2100 may further include a flash translation layer (FTL) 2120, an authentication device (SJTAG) 2130, a packet manager 2140, a buffer memory 2150, an error correction code (ECC) engine 2160, and an advanced encryption standard (AES) engine 2170.

The storage controller 2100 may further include a working memory on which the flash translation layer 2120 is loaded, and a data write operation and a data read operation on the nonvolatile memory 2200 when the CPU 2110 operates the flash translation layer 2120.

The host interface 2180 may transmit/receive packets to/from the host. The packet transmitted to the host interface 2180 from the host may include a command or data to be written to the nonvolatile memory 2200, and the packet transmitted to the host from the host interface 2180 may include a response to the command or the data read from the nonvolatile memory 2200.

The memory interface 2190 may transmit data to be written to the nonvolatile memory 2200 to the nonvolatile memory 2200, or may receive the data read from the nonvolatile memory 2200. The memory interface 2190 may be realized to follow a standardized rule such as the toggle or the open NAND flash interface (ONFI).

The flash translation layer 2120 may perform many functions such as address mapping, wear-leveling, or garbage collection. The address mapping operation changes a logical address received from the host into a physical address for storing data in the nonvolatile memory 2200. The wear-leveling prevents a specific block from being excessively degraded by allowing the blocks in the nonvolatile memory 2200 to be uniformly used, and for example, it may be realized according to a firmware skill for balancing erase counts of physical blocks. The garbage collection obtains capacity usable in the nonvolatile memory 2200 by a method for duplicating valid data of the block to a new block and erasing the existing block.

The description on the authentication device given with reference to FIG. 1 to FIG. 15 may be identically applied to the authentication device 2130. The authentication device 2130 may be connected to the debugging device for debugging the storage device 2000. The authentication device 2130 may be connected to the debugging device, and may receive a master public key, a product public key, a product private key, and a certificate from the debugging device. The authentication device 2130 may communicate with the debugging device through a debugging interface. The authentication device 2130 may verify the master public key, the product public key, the product private key, and the certificate, and may allow debugging of the debugging device when the verification is successful.

The packet manager 2140 may generate a packet according to a protocol of the interface consulted with the host, or may parse various types of information from the packet received from the host. The buffer memory 2150 may temporarily store the data to be written to the nonvolatile memory 2200 or the data to be read from the nonvolatile memory 2200. The buffer memory 2150 may be installed in the storage controller 2100, and may also be arranged outside the storage controller 2100.

The ECC engine 2160 may perform an error detection and correction function on the read data that are read from the nonvolatile memory 2200. In detail, the ECC engine 2160 may generate parity bits for the program data to be programmed to the nonvolatile memory 2200, and the parity bits generated in this way may be stored in the nonvolatile memory 2200 with the write data. When reading data from the nonvolatile memory 2200, the ECC engine 2160 may correct errors of the read data by using the parity bits read from the nonvolatile memory 2200 with the read data, and may output error-corrected read data.

The AES engine 2170 may perform at least one of the encryption operation and the decryption operation on the data input to the storage controller 2100 by using a symmetric-key algorithm.

In an embodiment, the respective constituent elements or combination of two or more of the constituent elements described with reference to FIG. 1 to FIG. 14 may be realized with a digital circuit, a programmable or non-programmable logic device or array, and an application specific integrated circuit (ASIC).

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A storage device comprising:
an authentication device comprising at least one memory and at least one authentication controller in communication with the at least one memory; and
at least one processor in communication with the authentication device,
wherein the at least one authentication controller is configured to:
receive a certificate, a first public key, and a second public key from a debugger, wherein the certificate is generated based on a first private key, and wherein the first private key corresponds to the first public key,
authenticate the first public key,
based on successfully authenticating the first public key, authenticate the second public key, and
based on successfully authenticating the second public key, output a debugging enable signal, and
wherein the at least one processor is configured to:
receive a debugging signal from the debugger, wherein the debugging signal is sent in response to the debugging enable signal, and
perform debugging based on the debugging signal.

2. The storage device of claim 1,
wherein the first public key corresponds to a master public key of the storage device, and
wherein the second public key corresponds to a product public key generated using an encryption algorithm, wherein the encryption algorithm is also used to generate the master public key.

3. The storage device of claim 1,
wherein the at least one memory stores a first hash value of a master public key of the storage device, and
wherein the at least one authentication controller is further configured to:
generate a second hash value of the first public key, and
based on the first hash value matching the second hash value, identify the authentication of the first public key as being successful.

4. The storage device of claim 1,
wherein the at least one memory stores product information of the storage device, and
wherein the at least one authentication controller is further configured to:
based on successfully authenticating the first public key, generate a first hash value based on the product information and the second public key,
obtain a second hash value by decrypting the certificate using the first public key, and
based on the first hash value matching the second hash value, identify the authentication of the second public key as being successful.

5. The storage device of claim 4,
wherein the at least one authentication controller is further configured to:
concatenate the product information and the second public key to generate concatenated data, and
generate the first hash value by applying a hash algorithm to the concatenated data, and
wherein the hash algorithm is also used to generate the certificate.

6. The storage device of claim 5,
wherein the product information comprises an identification of the storage device and version information of the storage device, and
wherein the at least one authentication controller is further configured to:
concatenate the identification of the storage device, the version information of the storage device, and the second public key using a same concatenation order of data included in the certificate.

7. The storage device of claim 1,
wherein the at least one authentication controller is further configured to:
based on successfully authenticating the second public key, perform challenge-response authentication with the debugger.

8. The storage device of claim 7,
wherein the at least one authentication controller is further configured to:
generate a random number and transmit the same to the debugger based on: the authentication of the second public key being successful, the authentication device receiving a response signal from the debugger generated based on a second private key that corresponds to the second public key, the authentication device authenticating the response signal, and the authentication device outputting the debugging enable signal based on the authentication of the response signal being successful.

9. The storage device of claim 8,
wherein the at least one authentication controller is further configured to:
decrypt the response signal by using the second public key to obtain an authentication value, and
based on the random number matching the authentication value, identify the authentication of the response signal as being successful.

10. The storage device of claim 1,
wherein the at least one authentication controller receives an authentication request from the debugger, and
wherein the authentication request is based on the certificate, the first public key, the second public key, and a second private key that corresponds to the second public key, and wherein the authentication request is not based on the first private key.

11. An authentication device comprising:
at least one nonvolatile memory storing a first hash value and product information;
an encryption engine in communication with the at least one nonvolatile memory; and
at least one controller in communication with the at least one nonvolatile memory and the encryption engine,
wherein the at least one controller is configured to:
receive from a debugger a first public key, a second public key, and a certificate,
verify the first public key using the first hash value, and
based on successfully verifying the first public key, verify the second public key and the certificate using the first hash value, the product information, and the encryption engine.

12. The authentication device of claim 11,
wherein the product information comprises an identification and version information, and
wherein the at least one nonvolatile memory comprises:
a first one time programmable (OTP) memory storing the first hash value;
a second OTP memory storing the identification; and
a third OTP memory storing the version information.

13. The authentication device of claim 12,
wherein the at least one controller is further configured to update the version information based on a version update.

14. The authentication device of claim 11,
wherein the encryption engine comprises:
a hash algorithm circuit configured to generate a hash value using a hash algorithm;
a public key accelerator configured to decrypt the certificate; and
a random number generator configured to generate random numbers.

15. The authentication device of claim 14,
wherein the hash algorithm circuit is configured to generate a second hash value of the first public key and to generate a third hash value based on the product information and the second public key,
wherein the public key accelerator is configured to decrypt the certificate by using the first public key to obtain a fourth hash value, and
wherein the at least one controller is further configured to:
identify the verification of the first public key as being successful based on the first hash value matching the second hash value, and
identify the verification of the second public key and verification of the certificate to be successful based on the third hash value matching the fourth hash value.

16. The authentication device of claim 15,
wherein the at least one controller is further configured to:
based on successfully authenticating the second public key and the certificate, perform challenge-response authentication with the debugger.

17. The authentication device of claim 16,
wherein the random number generator is configured to, based on the verification of the second public key and the certificate being successful, generate a random number,
wherein the public key accelerator is configured to, based on receiving a response signal from the debugger, decrypt the response signal by using the second public key to output an authentication value, and
wherein the at least one controller is further configured to:
transmit the random number to the debugger as a challenge signal, and
based on the random number matching the authentication value, identify the challenge-response authentication as being successful.

18. An authentication system comprising:
an authentication server configured to:
manage product information of a storage device, a first public key, a first private key that corresponds to the first public key, a second public key, and a second private key that corresponds to the second public key, and
generate a certificate based on the product information and the first private key in response to a request of an authenticated debugger, the authenticated debugger configured to:
based on storing the certificate, the first public key, the second public key, and the second private key:
cancel a connection with the authentication server, and
send a debugging request to a storage device using the certificate, the first public key, the second public key, and the second private key; and
the storage device configured to:
verify the certificate, the first public key, and the second public key,
based on successfully verifying the certificate, the first public key, and the second public key, transmit a challenge signal to the authenticated debugger, and
based on receiving a response signal from the authenticated debugger, verify the response signal using the second public key, wherein the response signal is generated based on the second private key.

19. The authentication system of claim 18,
wherein the authentication server is further configured to:
generate concatenated data by concatenating the product information and the second public key,
generate a hash value by applying a hash algorithm to the concatenated data, and
generate the certificate by signing to the hash value using the first private key.

20. The authentication system of claim 18,
wherein the storage device is further configured to:
verify the certificate, the first public key, and the second public key, and
based on successfully verifying the certificate, the first public key, and the second public key, generate a random number and transmit the random number to the authenticated debugger as the challenge signal, and
wherein the authenticated debugger is further configured to:
generate the response signal by signing to the random number using the second private key, and
transmit the response signal to the storage device.

21. An authentication system comprising:
a storage device;
an authentication server, wherein the authentication server stores authentication data comprising a first public key, a first private key that corresponds to the first public key, a second public key, a second private key that corresponds to the second public key, and product information of the storage device; and
a debugger,
wherein the authentication server is configured to generate a certificate based on the product information and the first private key in response to a request from the debugger,
wherein the debugger is configured to:
obtain the authentication data and the certificate from the authentication server before accessing the storage device,
connect to the storage device via a debugging interface, and
send a debugging request to the storage device using the authentication data, and
wherein the storage device is configured to:
verify the certificate, the first public key, and the second public key,
based on successfully verifying the certificate, the first public key, and the second public key, transmit a challenge signal to the debugger, and
based on receiving a response signal from the debugger, verify the response signal using the second public key, wherein the response signal is generated based on the second private key.
